(19) United States
(12) Patent Application Publication
(10) Pub. No.: US 2007/0120416 A1
(43) Pub. Date: May 31, 2007

(54) Wheel assembly

(76) Inventors: Allen A. Pusch, Calgary (CA); Gregory J. Honey, Bracken (CA)

Correspondence Address: MILES & STOCKBRIDGE PC, 1751 PINNACLE DRIVE, SUITE 500, MCLEAN, VA, 22102-3833, US

(21) Appl. No.: 11/603,164

(22) Filed: Nov. 22, 2006

(30) Foreign Application Priority Data
Nov. 28, 2005 (CA) 2528072

(51) Int. Cl. B60B 3/10

(52) U.S. Cl. 301/64.304; 301/5.1; 301/105.1

(57) ABSTRACT

A light weight wheel structure having a hub member of substantially an elongated configuration of constant cross section defining a plurality of openings therethrough, and including a pair of end plates which are held in recessed areas at opposite ends of the hub member by way of a plurality of fasteners extending through the plurality of openings in the hub member. The hub member is of a form capable of being formed of material, such as aluminum, by an extrusion process, whereby a continuous outer cylindrical surface is provided for the mounting of a tire formed of elastomeric material.

### FIELD OF THE INVENTION

This invention relates to a relatively light weight, wheel structure of the type which can be used as a caster wheel, such as for load carrying trolleys, and is particularly suitable for use as a gauge wheel on agricultural equipment, such as headers for swathers, combines and the like.

### BACKGROUND OF THE INVENTION

A common form of gauge wheels utilized on combine headers are modified wheels which are commercially available for other industrial applications, such as fork lifts. These wheels are generally of a heavy duty build, and thus are not only expensive but add to the implement unnecessary weight which for a number of reasons is undesirable.

### SUMMARY OF THE INVENTION

It is an object of the present invention to provide a light weight wheel structure which is of relatively low cost and provides sufficient structural strengths for satisfactory operation under rather adverse working conditions.

According to one aspect of the present invention there is provided a wheel structure which includes a hub member having a cylindrical outer surface extending between opposite end surfaces and being of substantially constant cross-section configuration throughout the length thereof, the cross-sectional configuration defining a plurality of openings extending longitudinally through the hub member. There are also provided a pair of end plates having inner surfaces abutting the opposite end surfaces of the hub member with a plurality of fasteners, one each extending through the plurality of openings and applying forces against the end plates for drawing the inner surfaces of the end plates against opposite end surfaces of the hub member.

In a preferred embodiment of the invention, the hub member is formed as an extruded body of aluminum.

According to another aspect of the invention there is provided a wheel structure including an elongated hub member of extruded material having a cylindrical outer surface and being of constant cross-section configuration throughout substantially the length thereof, and wherein the cross-sectional configuration defines a plurality of openings extending longitudinally through the hub member between opposite ends thereof. A pair of end plates are included, each having an outer edge extending peripherally about inner side surfaces. The hub member has opposite end surfaces defined in a recessed area in the opposite ends and surrounded by a circumferential rim flange shaped to engage the outer edges of the end plates. The wheel structure further includes a plurality of fasteners applying a force against the end plates for holding the inner side surfaces of the end plates against the opposite end surface of the hub member and within the recessed area.

Yet another aspect of the invention is in the form of a hub member for use in fabricating a wheel structure, the hub member including an extruded body having opposite plate engaging end surfaces disposed normal to an longitudinally extending axis of the body, the extruded body being of constant cross-sectional configuration throughout a length thereof extending between the end surfaces and defining longitudinal extending, fastener receiving openings therethrough, the body being of circular shape in cross-section providing an outer tire mounting cylindrical surface.

The present invention also resides in a method of making a wheel structure of the type having a wheel hub member by first providing a core element defined within by an outer cylindrical tire supporting surface extending between opposite ends which provide seating areas for bearing mounting plates. The method includes the steps of forming by extrusion of a material through a die, the extrusion providing a continuous length of hub stock having at least a central opening extending longitudinally therethrough, and then cutting a hub member from the length of hub stock, prior to machine squaring opposite ends of the hub member to the required length of the individual wheel hub. There is then formed in the opposite ends of the wheel hub seating areas for attaching bearing supporting elements coaxially within the central opening of the hub stock.

Preferably the material utilized as the extruding material is aluminum.

### BRIEF DESCRIPTION OF DRAWINGS

In the accompanying drawings, which show specific embodiments of the invention as examples,

FIG. 1 is a perspective view of one embodiment of an assembled wheel structure of the present invention;

FIG. 2 is a side view of the wheel structure of FIG. 1;

FIG. 3 is a cross sectional view of the wheel structure as seen from line 3-3 of FIG. 2;

FIG. 4 is a perspective view of an extruded length of a hub core stock of the present invention for use in forming a hub member of the wheel structure as shown in FIGS. 1 to 3;

FIG. 5 is a perspective view of a core element as severed from the continuous core stock shown in FIG. 4;

FIG. 6 is arm end view of the core element shown in FIG. 5;

FIG. 7 is a view of the core element similar to that of FIG. 5, but as squared and counterbored for the subsequent preparation of a finished wheel structure;

FIG. 8 is an exploded view of the wheel structure of FIGS. 1 to 3;

FIG. 9 is a side view of another embodiment of the invention and showing the wheel on a mounting framework;

FIG. 10 is a rear view of the wheel structure as shown in FIG. 9; and

FIG. 11 is a sectional view of the wheel structure as seen from line 11-11 of FIG. 10.

### DETAILED DESCRIPTION OF THE INVENTION

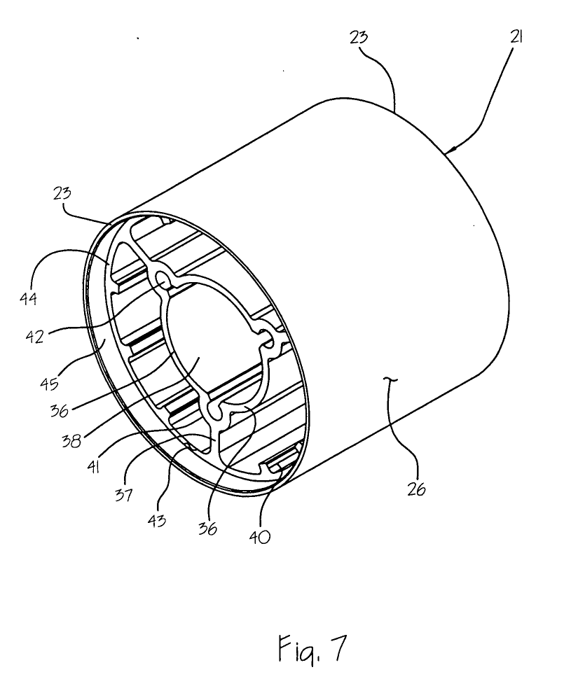

In the drawings, the wheel assembly of the present invention is denoted generally by the reference number 20, and as will become more apparent in the description below, the wheel assembly 20, includes a basic component which is a hub member 21, preferably formed as an extruded and subsequently machined body as shown most clearly in FIG. 7.

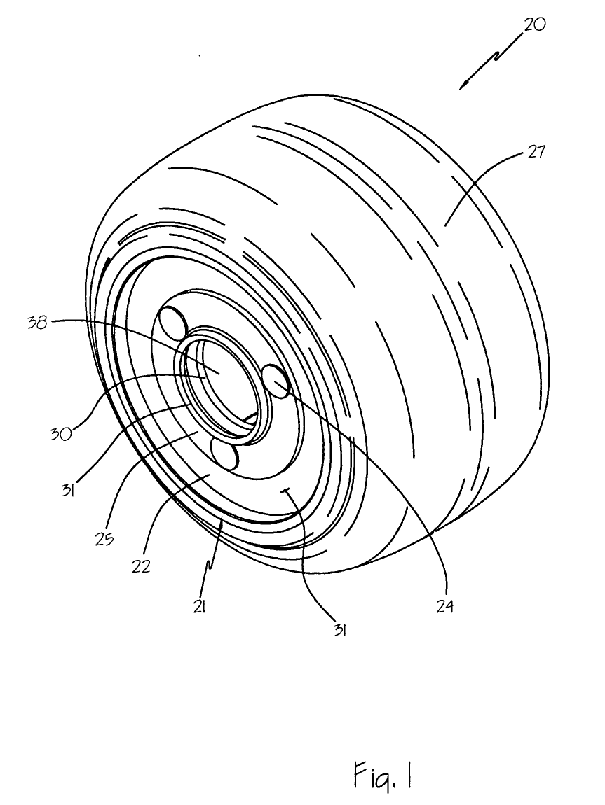

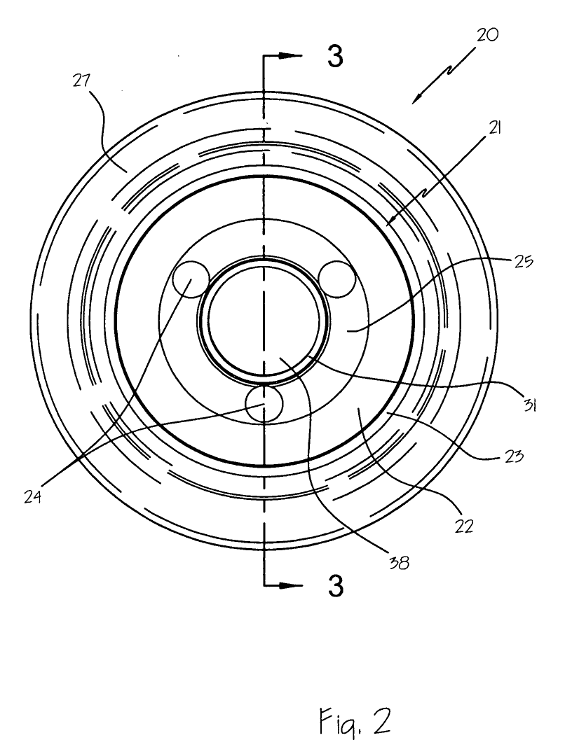

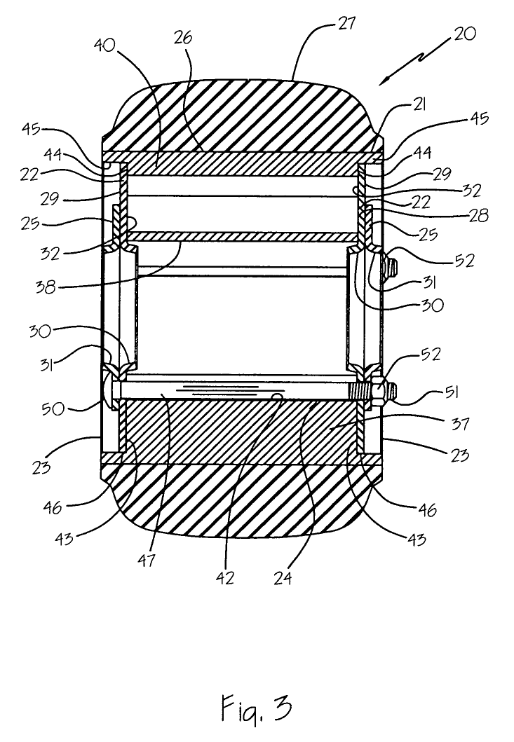

In an assembled condition of the wheel assembly 20, end plates 22,22 are secured to opposite ends 23,23 of the hub member 21 by fasteners 24. The hub member 21 provides between its opposite ends 23,23 a cylindrical outer surface 26 (FIG. 3) to which is affixed a tire 27. In the embodiment shown in FIGS. 1 to 8, the end plates define a central opening within an in-turned flange 30.

Second or outer plates 25 having inner faces 28 (FIG. 3) are held against outer faces 29,29 of the end plates 22,22 by the same fasteners 24, and the outer plates 25 have out-turned flanges 31 which define therewith a central opening coaxial with the central opening of the end plates 22,22. As will become more apparent below, the in-turned flanges 30 of each end plate 22 and the out-turned flanges of the outer plate 25 together provide a bearing cage for supporting an axle containing bearing as described in more detail below.

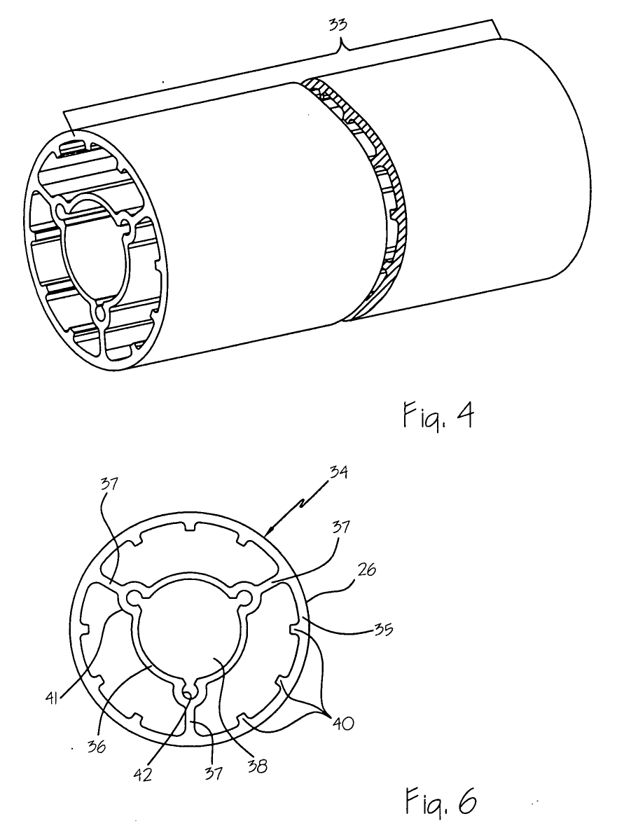

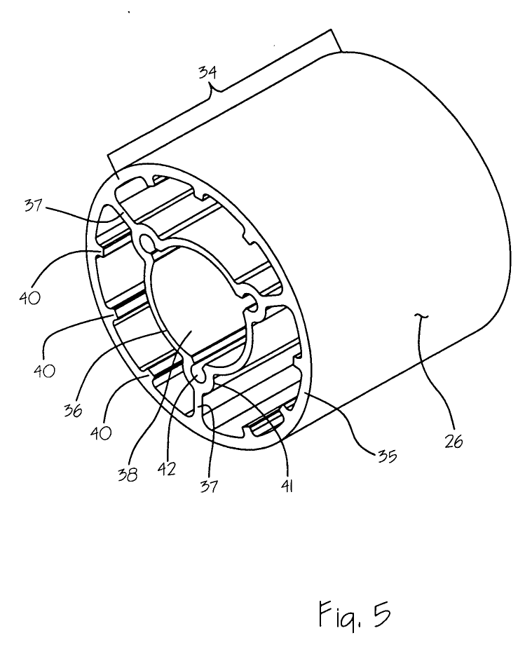

The nature of the hub member 21 is of significance, and reference to FIGS. 4 to 7 is made to facilitate an understanding of its formation. A particular cross-sectional configuration is selected to provide the required endurance and assembling characteristics of the hub member 21. While various methods, such as casting, injection molding, sintering, etc. could be used to form the hub member 21, it is believed more feasible to form a continuous element of hub stock 33 (FIG. 4), which has a selected cross-section configuration and is extruded to a length which is a number of times the length of a separate hub core member 34 (FIG. 5) for use in forming the final hub member 21. The cross-sectional configuration of the hub stock 33 is consistent, of course, throughout its length by this forming process. In a wheel structure for the use described below, the material which appears most desirable both in relation to cost and endurance is aluminum. It is possible for economical and/or other requirements for different wheel structures, to use other materials, including metal alloys and extrusible plastics, which may be more feasible. Moreover, the configuration of the cross-section could be varied for different applications. With respect to the particular cross-sectional configuration of the core member 34 (FIGS. 5 and 6), various characteristics may be considered, including the amount of material to be used, strength, weight and structural features, such as those which are feasible for the attachment of additional parts to form the complete wheel structure.

The extrusion process does provide, of course, the continuous and uniform cylindrical outer surface 26 extending between the opposite outer ends of each core member 34 cut therefrom. The peripheral part or rim portion 35 of the core member 34 may be relatively thin in relation to the overall radius of the hub core cylindrically shaped member 34, and the rim portion 35 is joined to a central axial portion 36 by a plurality of longitudinally continuous radial webs 37. A plurality of longitudinally continuous ribs 40 are formed integrally on an inner surface of the rim portion 35 between the radial webs and extend the length of the core member 34. The purpose of the ribs 40 is, among other reasons, to reinforce the strength of rim portion 35. At the juncture of the webs 37 with the central axial portion 36, enlargements 41 are formed to provide longitudinally extending openings 41 which are generally of circular cross-sections to receive the fasteners 24 as will be described further below. A central opening 38 provided by the central axial portion 36 extends, of course, the full length of the hub core member 34, as do the openings 42.

In the preparation of the hub member 21 (FIGS. 5 and 6) for assembly into a completed wheel assembly 20, the hub core member 34 is severed from the length of extruded hub stock 33 (FIG. 4). It may be then machine squared at opposite ends to provide opposite ends 23,23 of the hub member 21 in parallel planes to which the central axis of the hub member is normal. The ends 23,23 are then machined to provide counterbores to form recessed end surfaces or areas 43,43 (FIG. 3) inward of the outermost ends 23,23 of the hub member 21. In forming the recessed areas, the counterbore is selected in diameter to remove the innermost part of the rim portion 35 of the hub core member 34 as well as the outermost ends of the radial webs 37, hub portion 36, and ribs 40, so that a recessed shoulder 44 is provided within an outer circumferential rim flange 45. The recessed shoulder 44, of the rim portion 35, and the ends webs 37, ribs 40 and central axial portion 36 are all in the same recessed plane which forms the recessed areas 43,43 normal to the axis of the hub member.

Prior to assembling the wheel structure, an elastomeric material, preferably rubber or polyurethane is molded, vulcanized or otherwise bonded to the outer surface of the hub member 21 to form the tire 27. As shown in FIG. 3, for example, the tire is of solid configuration and has a slightly curved outer surface and more sharply curved outer corner edges.

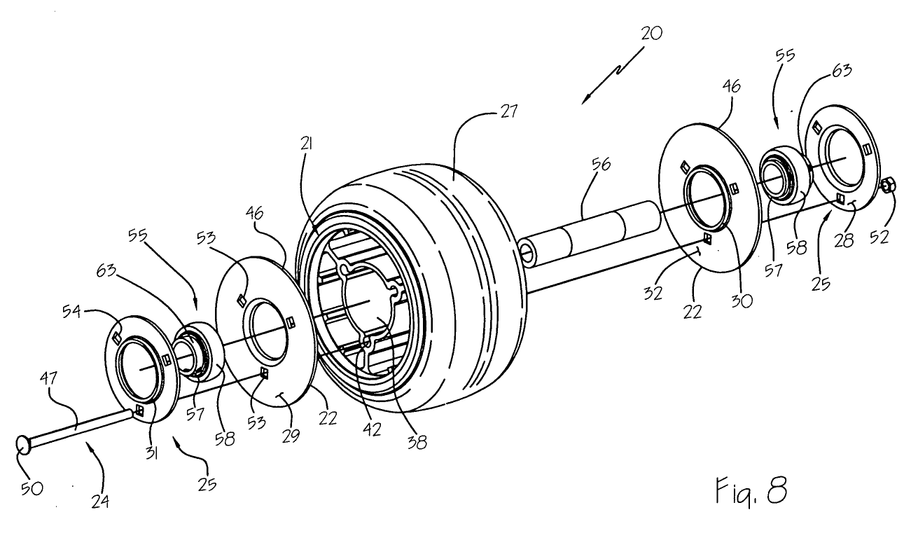

The end plates 22, 22 in the embodiment of the invention as seen in FIGS. 3 and 8 are preferably formed of plate steel and may be made as a stamped part to provide the in-turned flange 30 to form a bearing cage with the out-turned flange 31 or outer plate 25. The disks 22,22 have outer peripheries 46,46 which are of a diameter to fit closely within the internal circumference of the rim flange 45. When assembled the end plates are pulled tightly into the counterbore so that the inner surfaces 32,32 thereof tightly engage machined recessed shoulders 44 as well as the ends of the central axial portion 36, webs 33, and ribs 40, all of which are in the same plane thus forming the recessed areas 43,43. The fasteners 24 in the illustrated embodiments include three bolts 47 of the type having carriage heads 50 with the opposite ends being threaded at 51 to receive nuts 52. The end plates 29,29, have three bolt receiving holes 53, while the outer plates also have three bolt receiving holes 54, the holes 53 and 54 being on the same radius and of the same spacing as the longitudinal openings 42 through the hub member 21. Thus, the aligned holes receive bolts 47 prior to the nuts 52 being tightened to bring the end plates 22,22 into tight engagement with the recessed areas 43,43 at the opposite ends of the hub member 23, and to also bring the inner surfaces 28,28 and the outer plates into tight engagement with the outer surfaces 29,28 of end plates 22,22. As shown, the holes 53 and 54 in the end plates 22 and outer plates 25 respectively, are of square configuration so as to receive the squared head portion of the carriage bolts 47 in order to facilitate assembly of the overall wheel structure.

FIG. 8 shows the parts present for a more final form of a wheel assembly. As previously described, the in-turned flange 30 of each end plate 22 and the out-turned flange 31 of its associated outer plate 25 provide a bearing seat. To install a bearing 55 within this seat, once the end plates have been brought into position an inner tubular axle member 56 having opposite ends for extending respectively through the inner races 57 of a pair of the bearings 55,55 is positioned within the central opening 38. The bearings are then slid over the opposite ends of the tubular member, and outer races 58,58 of the bearings thus being installed are brought into contact with the in-turned flanges 30 of the outer plates 22,22. The outer plates 25,25 are then brought against the outer surfaces 29,29 of the end plates with the out-turned flanges 31,31 then engaging the outer races 58,58 as the bolts are tightened so as to entrap the bearings 55,55 in a seated position between the flanges 30,31 of the end plates 22,22 and the outer plates 25,25.

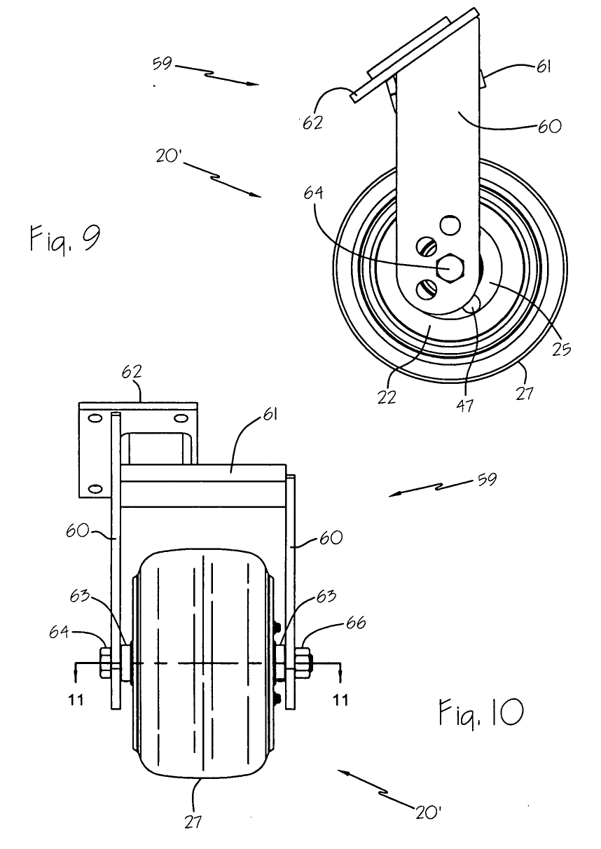

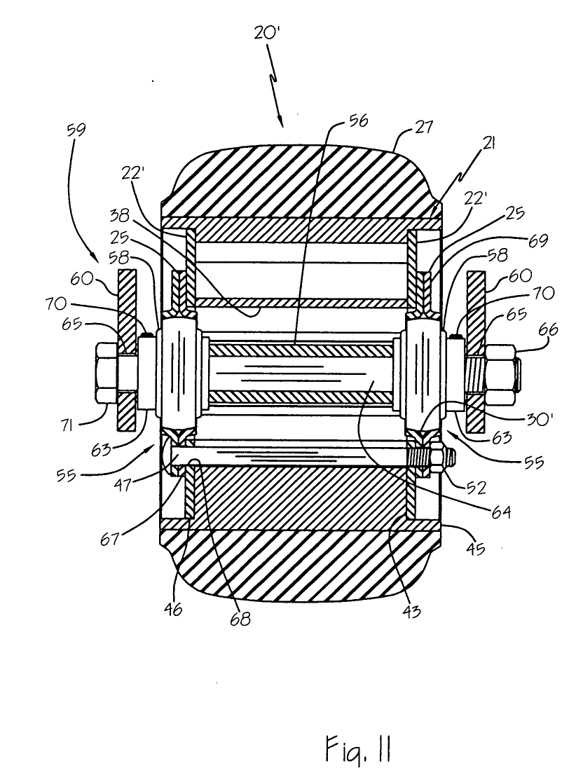

There is shown in FIGS. 9 to 11 a slightly modified form 20′ of a wheel structure, there also being illustrated a more detailed manner of mounting the wheel structure as used, for example, on an implement such as a harvesting header. The wheel is mounted in a framework 59 between a pair of spaced, downwardly depending leg members 60,69, which are joined at upper ends to a transverse member 61. The framework 59 further includes a mounting plate 62 adapted to bolt the framework 59 to a swivel type mechanism for connecting to a header structure so as to allow the wheel structure to operate as a gauge wheel for partially supporting outer ends of a header (not shown) to thereby controlling its height above the ground surface on which the wheel structure rides. As most clearly shown in FIG. 11, the wheel assembly 20′ is mounted in the framework 59 by way of an axle bolt 64 which extends through openings 65,65 of the leg members 60,60. The bearings 55,55 are of a type in which the inner race 57 has an extension 63 formed integrally at one side thereof. The extension has set screws 70 screwed into threaded bores therein so that on tightening of the screws 70, the inner races 57,57 are affixed to the bolt 64 and thereby establish a fixed position of the wheel assembly relatively to the axle forming bolt. Nut 66 is threaded onto bolt 64 and abuts the outside of one of the leg members 60, while a head 71 of bolt 64 engages the outside of the other leg member 60.

The entire structure of the hub member 21 shown in wheel assembly 20′ may be identical to that shown in the previously described embodiment, and this is also the case for outer plates 25,25. Also while the fit of end plate 22′ within the recessed end areas of the hub member is the same as in the earlier embodiment, the design of the end plate structure may be in a form which allows a less expensive structure in that the end plate may be simply cut or formed from flat sheet of metal, such as steel or aluminum, without having to press or otherwise form an in-turned flange 32 to provide part of the bearing cage. Instead, for each bearing cage there is simply used a second outer plate 25, but as shown in FIG. 11 this plate is designated as secondary outer plate 67. As illustrated, the secondary outer plate 67 is reversed so that the surface previously designated as the inner face 28 of the outer plate 25 becomes the outer face 69 of the secondary outer plate 67, and the out-turned flange 31 of the outer plate 25 becomes an in-turned flange 30′ of the secondary outer plate 67. The bolt 47 which is passed through the aligned openings of outer plate 25, secondary outer plate 67, and end plate 22′ at either side of the hub member 21 hold all members in tight engagement with the out-turned flange of the outer plate 25 and the in-turned flange 30′ of the secondary outer plate 67 providing the bearing cage.

It will be apparent that the generally hollow nature of the hub core member 34 and the fact it may be formed of a light metal, as well as the relatively small volume of steel used in the end plates 22 and outer plates 25, provides a light weight structure. Moreover, because of the manner in which the end plates 22,22 are fitted within the recessed areas 43,43 good provision exists for transferring the load forces between the end plates and the rim portion of the hub member. The fit further prevents against soil and other debris from migrating to the interior of the wheel structure. Because of the simplicity of the forming and machining of the hub core member subsequent to the extrusion forming of the elongated hub stock and the need of a few additional components of non-complex form to complete the structure, the finalized structure is of competitive cost.

While specific embodiments have been presented for sake of explanation, variations within the scope of the spirit of the appending claims will be apparent to those skilled in the art.

1. A wheel structure comprising;
a hub member having a cylindrical outer surface extending between opposite end surface and being of constant cross-section configuration throughout substantially the length thereof,
said cross-sectional configuration defining a plurality of openings extending longitudinally through said hub member,
a pair of end plates having inner surfaces abutting said opposite end surfaces of said hub member, and
a plurality of fasteners, one each extending through said plurality of openings and applying a force against said end plates for drawing said inner surfaces of said end plates against the opposite end surface of said hub member.

2. A wheel structure as defined in claim 1, wherein said hub member is formed as an extruded body of aluminum.

3. A wheel structure as defined in claim 2, wherein said pair of end plates are formed of steel and have an outer peripheral surface of less diameter than the outer cylindrical surface of said hub member.

4. A wheel structure as defined in claim 3, wherein said extruded body is counterbored at each end to form plate receiving recesses and provide outer circumferential rims for closely receiving the outer peripheral surface of one each of said end plates.

5. A wheel structure as defined in claim 4, wherein said end plates have openings extending therethrough for alignment with said plurality of openings extending through the length of said hub member.

6. A wheel structure as defined in claim 5, wherein said fasteners include bolt means each extending through aligned openings of said hub member and said end plates for drawing said end plates tightly into the recesses in opposite ends of said hub member.

7. A wheel structure as defined in claim 1, and further comprising a tire of elastomeric material affixed to said cylindrical outer surface of said hub member, said tire being bonded to said cylindrical outer surface,
said elastomeric material being selected from a group of materials including rubber and polyurethane.

8. A wheel structure as defined in claim 5, wherein said end plates provide aligned central openings; and further comprising:
a pair of mating bearing cage members secured in the central opening of each end plate.

9. A wheel structure as defined in claim 8, wherein each of said pair of bearing cage members is provided with peripheral flanges,
said flanges having a plurality of openings in alignment with said plurality of openings through the length of said hub member, and wherein
said fasteners include bolt means each extending through aligned openings in said hub member, said end plates and said bearing cage members, whereby said bearing cage members are held in bearing holding position.

10. A wheel structure comprising;
an elongated hub member of extruded aluminum having a cylindrical outer surface and being of constant cross-section configuration throughout substantially the length thereof,
said cross-sectional configuration defining a plurality of openings extending longitudinally through said hub member between opposite ends thereof,
and a tire of elastomeric material bonded to said cylindrical outer surface of said hub member,
a pair of end plates each having a peripheral edge about inner side surfaces,
said hub member having opposite end surfaces defined in a recessed area in said opposite ends and surrounded by a circumferential rim flange shaped to engage said peripheral edges of said end plates, and
a plurality of fasteners applying a force against said end plates for holding said inner side surfaces of said end plates against said opposite end surface of said hub member and within said recessed area.

11. A wheel structure as defined in claim 10, wherein;
each of said end plates provides an outer surface surrounding a central opening defined by an in-turned flange,
and further comprising a second pair of plates having inner faces for engagement with the outer surfaces of said end plates,
each of said second pair of plates having a central opening defined by an out-turned flange,
said in-turned flange of each end plate and said out-turned flange of each second pair of plates engaged with said end plate providing a seat for a bearing contained in the central opening of each end plate.

12. A wheel structure as defined in claim 11, wherein;
said end plates and said second pair of plates have aligned openings therethrough and arranged to align with the plurality of openings extending through the length of said hub member, and wherein;
said plurality of fasteners include bolt means one each extending through the aligned openings of said end plates, second plates and the hub member for drawing said plates and hub member into an assembled unitary condition.

13. A hub member for use in fabricating a wheel structure, said hub member comprising;
an extruded body having opposite plate engaging end surfaces disposed normal to an longitudinally extending axis of said body,
said extruded body being of constant cross-sectional configuration throughout a length thereof extending between said end surfaces and defining longitudinal extending, fastener receiving openings therethrough,
said body being of circular shape in cross section providing an outer tire mounting, cylindrical surface.

14. A hub member as defined in claim 13, wherein said extruded body is formed of extruded aluminum in a continuous length of extrusion, and
said extruded body is individually severed from said continuous length of extrusion to provide said length of said hub member.

15. A hub member as defined in claim 14, wherein said extruded body has counterbores formed in said surfaces and providing plate receiving recesses encircled by a rim flange.

16. In a method of making a wheel structure of a type having a wheel hub member by first forming a core element surrounded by an outer cylindrical tire supporting surface extending between opposite ends providing seating areas for bearing mounting end plates;
comprising the steps of:
forming by extrusion of a material through a die a continuous length of hub stock having at least a central opening extending longitudinally therethrough,
cutting a separate hub member from said length of hub stock,
machine squaring opposite ends of said hub member to the required length of said wheel hub, and
forming in said opposite ends of said wheel hub seating areas for attaching bearing elements coaxially within said central opening of said hub stock.

17. In the method of claim 16, wherein the material is aluminum,
wherein the step of forming the seating areas includes counterboring said opposite ends of said wheel hub to provide in each end a recessed, plate receiving opening surrounded by a rim flange shaped for closely receiving bearing mounting plates.

18. In the method of claim 17, and further including the step of forming a plurality of fastener receiving openings spaced radially outward from said central opening lengthwise through said hub stock during the extrusion step.

19. A method of making a wheel structure including the steps of claim 18, and
further comprising the steps of;
providing bearing mounting plates having a plurality of fastener receiving openings for alignment one each with said spaced openings provided in said extrusion;
inserting one each of said bearing mounting plates in each of the plate receiving openings in each end of said wheel hub, and
securing said bearing mounting plates in place by tensioning mounting bolts placing one each through the aligned openings in said bearing mounting plates and said hub member.

20. A method of making a wheel structure including the steps in the method of claim 18, and further comprising the step of bonding on to the outer cylindrical tire supporting surface of said wheel hub an elastomeric material selected from a group of materials including rubber and polyurethane material to thereby form a wheel tire.
